(19) United States
(12) Patent Application Publication
(10) Pub. No.: US 2008/0278749 A1
(43) Pub. Date: Nov. 13, 2008

(54) IMAGE FORMING APPARATUS

(76) Inventor: Junji Sato, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/100,323

(22) Filed: Apr. 9, 2008

(30) Foreign Application Priority Data
May 11, 2007 (JP) 2007-126729

(51) Int. Cl. G06F 15/00

(52) U.S. Cl. 358/1.15

(57) ABSTRACT

Disclosed is an image forming apparatus including: an image forming section to form images on sheets; a display section to display an operation screen; an operation section to receive input of a condition of image forming using the operation screen; a storage section to store setting information of image forming input from the operation section; and a control section to control image forming, wherein when a plurality of pieces of setting information of jobs are successively input, the control section stores the plurality of pieces of setting information of the jobs as one piece of setting information of a programming job in the storage section and the plurality of pieces of setting information of the jobs may be read out as the setting information of the programming job.

### BACKGROUND

1. Field of the Invention

The present invention relates to an image forming apparatus which forms an image on a sheet.

2. Description of Related Art

Usually, an image forming apparatus comprises a function to register a setting of a job in a non-volatile memory and read out the setting to set the apparatus. For example, Japanese Patent Application Laid-Open Publication No. 2005-102249 and Japanese Patent Application Laid-Open Publication No. 2004-112067 disclose this function. Here, a job includes setting information in which a reading condition of a document and an image forming condition is set and image data, and shows a unit of processing of image forming. Usually, processing in which the reading condition of a document and the image forming condition are the same is discussed as one job.

There is also an apparatus comprising a function of when a book with a plurality of pages where a reading condition of a document and an image forming condition varies from page to page is output, the book with the plurality of pages is output by setting a plurality of jobs and successively performing the plurality of jobs. Such jobs where a plurality of jobs are output together are called programming jobs.

There are image forming apparatuses comprising a function of setting and performing a programming job, however, there is no apparatus comprising a function in which a setting of a programming job is registered in a memory and then later, the setting of the programming job is read out from the memory to be performed.

Thus, there is a problem of when image forming of a book and the like is performed using the function of the programming job, even when the same setting is used may times, inputting a setting of a plurality of jobs need to be done each time.

Usually, an inputting a setting of a job and registering the job in a memory is performed by displaying an operation screen on a display section, however in a programming job, a plurality of types of job conditions need to be input, and it is difficult to input all conditions of the programming job with only one operation screen or read out the setting of the programming job with one operation screen. Thus, such operation is difficult for a user to understand if no measures are taken.

### SUMMARY

The present invention has been made in consideration of the above problems, and it is one of main objects to provide an image forming apparatus in which when a setting of a programming job is used many times, the process of inputting a setting may be omitted and a setting registration and a read out processing of a programming job may be easily understood and done by a user.

In order to achieve at least one of the above-described objects, according to a first aspect of the present invention, there is provided an image forming apparatus which forms an image on a sheet, comprising:

an image forming section to form images on sheets;

a display section to display an operation screen;

an operation section to receive input of a condition of image forming using the operation screen;

a storage section to store setting information of image forming input from the operation section; and

a control section to control image forming, wherein

when a plurality of pieces of setting information of jobs are successively input, the control section stores the plurality of pieces of setting information of the jobs as one piece of setting information of a programming job in the storage section and the plurality of pieces of setting information of the jobs may be read out as the setting information of the programming job.

### BRIEF DESCRIPTION OF THE DRAWINGS

The present invention will become more fully understood from the detailed description given hereinbelow and the appended drawings, and thus are not intended to define the limits of the present invention, and wherein;

FIG. 1 is a diagram showing a structure of an image forming apparatus of the present embodiment;

FIG. 2 is a block diagram showing a control system of an image forming apparatus of the present embodiment;

FIG. 3 is a diagram explaining a form of a registration processing and a read out processing of a normal job;

FIG. 4 is a diagram explaining a setting of a programming job;

FIG. 5 is a diagram explaining a content of an image forming processing performed with the setting of the programming job shown in FIG. 4;

FIG. 6 is a diagram for explaining a form of a registration processing and a read out processing of the programming job;

FIG. 7A is an image showing an operation screen of a first process when the programming job is registered;

FIG. 7B is an image showing an operation screen of a second process when the programming job is registered;

FIG. 7C is an image showing an operation screen of a third process when the programming job is registered;

FIG. 8A is an image showing an operation screen of a fourth process when the programming job is registered;

FIG. 8B is an image showing an operation screen of a fifth process when the programming job is registered;

FIG. 8C is an image showing an operation screen of a sixth process when the programming job is registered;

FIG. 9A is an image showing an operation screen of a seventh process when the programming job is registered;

FIG. 9B is an image showing an operation screen of an eight process when the programming job is registered;

FIG. 9C is an image showing an operation screen of a ninth process when the programming job is registered;

FIG. 10A is an image showing an operation screen of a tenth process when the programming job is registered;

FIG. 10B is an image showing an operation screen of an eleventh process when the programming job is registered;

FIG. 10C is an image showing an operation screen of a twelfth process when the programming job is registered;

FIG. 11A is an image showing an operation screen of a thirteenth process when the programming job is registered;

FIG. 11B is an image showing an operation screen of a fourteenth process when the programming job is registered;

FIG. 11C is an image showing an operation screen of a fifteenth process when the programming job is registered;

FIG. 12A is an image showing an operation screen of a sixteenth process when the programming job is registered;

FIG. 12B is an image showing an operation screen of a seventeenth process when the programming job is registered;

FIG. 12C is an image showing an operation screen of an eighteenth process when the programming job is registered;

FIG. 13 is an image showing an operation screen when the programming job is read out;

FIG. 14 is a flow chart showing a process of registration processing of setting information of a normal job or a program job; and

FIG. 15 is a flow chart showing a process of read out processing of setting information of a normal job or a program job.

### DETAILED DESCRIPTION OF PREFERRED EMBODIMENTS

A preferred embodiment reflecting an aspect of the present invention will be described with reference to the drawings. However, the scope of the invention is not limited to the illustrated examples.

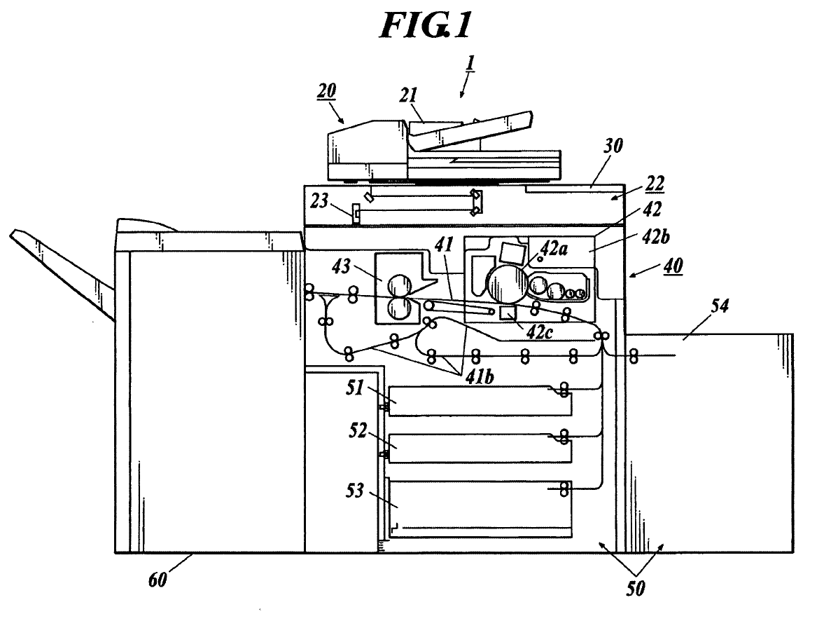

FIG. 1 is a diagram showing a structure of an image forming apparatus of the present embodiment.

The image forming apparatus 1 of the present embodiment is an apparatus for reading a document image and forming an image on a sheet according to the read image data. As shown in FIG. 1, the image forming apparatus 1 comprises an image reading section 20 for reading a document image, a display/operation section 30 for displaying a screen for operation and receiving input of an operation instruction from a user, a printer section 40 for forming an image on a sheet, a sheet feeding mechanism 50 for supplying a plurality of types of sheets, a sheet ejecting mechanism 60 for ejecting sheets with images formed and finishing such as book binding, etc.

The image reading section 20 comprises a scanner section 22 for scanning a document placed on a platen glass with an image sensor 23 such as a CCD (Charge Coupled Device) and generating image data with the document image, an automatic document feeding mechanism (ADF: Auto Document Feeder) 21 for conveying a plurality of documents to be successively read in the scanner section 22, and the like.

The printer section 40 is for forming an image using for example, electrophotography and comprises an image forming section 42 for forming a toner image on a sheet according to image data, a fusing section 43 for fusing the toner image, a conveying path 41 for conveying the fed sheet to the image forming section 42, a conveying path 41b for double sided printing which turns over and conveys the sheet with the image formed on one side to the image forming section 42 again, and the like. The image forming section 42 includes a photoreceptor drum 42a for forming an image pattern on its surface by being exposed to light, a laser unit 42b for scanning the surface of the photoreceptor drum 42a with light according to the image data, a transfer unit 42c for transferring toner to the sheet, and the like, and the toner image formed on the photoreceptor drum 42a is transferred onto the sheet by passing the sheet between the photoreceptor drum 42a and the transfer unit 42c.

The sheet feeding mechanism 50 comprises for example, a plurality of sheet feeding trays 51 to 53 in which a plurality of types of sheets with different sheet types and sizes are accommodated and each tray feeds sheets separately, a sheet feeding unit 54 for accommodating and feeding a large amount of sheets, and the like.

The sheet ejecting mechanism 60 comprises a finisher mechanism to perform finishing such as folding a sheet in a predetermined form, a stacker for accommodating a large number of ejected sheets in a stacked state, a sorter for collating pages, and the like.

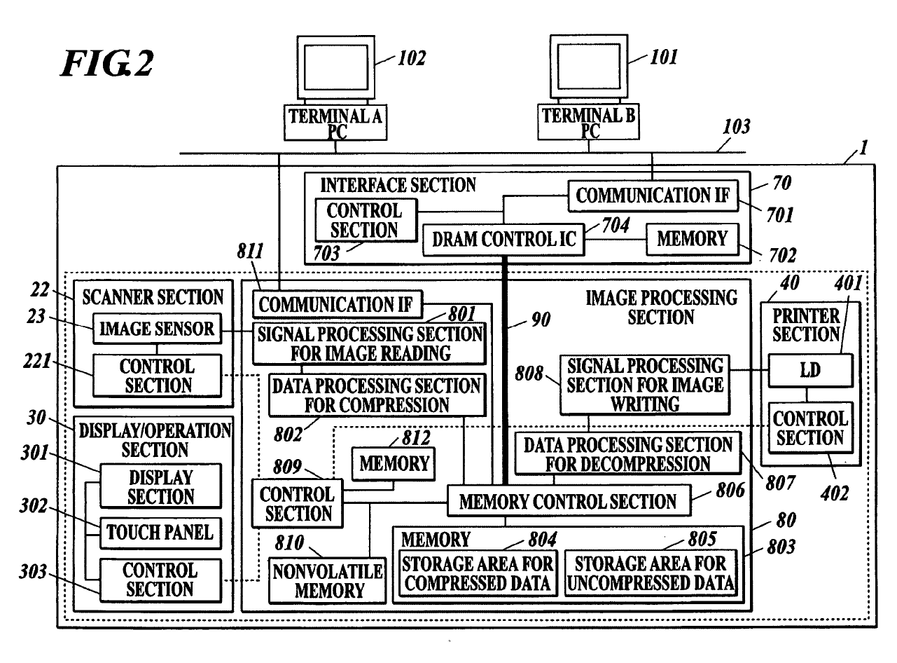

FIG. 2 is a block diagram showing a control system of an image forming apparatus 1 of the present embodiment.

As a control system, the image forming apparatus 1 of the present embodiment comprises an interface section 70 for exchanging image data with external terminals 101, 102 through a LAN (Local Area Network) 103 and an image processing section 80 for image processing of image data.

The interface section 70 is provided with a communication interface 701 for sending and receiving data through the LAN 103, a memory 702 for initially storing image data received from an external terminal through the communication interface 701, a memory control section 704 for reading and writing data in the memory 702 and input and output of data with the image processing section 80 through a bus 90, and a control section 703 for generally controlling the interface section 70 and the like. The control section 703 controls the scanner processing of transferring image data read with the scanner section 22 of the image forming apparatus 1 to the external terminals 101, 102, and controls the printer processing of sending image data sent from the external terminals 101, 102 to the printer section 40 to form the image on the sheet.

The image processing section 80 is provided with a signal processing section 801 for image reading which receives a read signal sent from the image sensor 23 of the scanner section 22 and converts the signal to the image data, a data processing section 802 for compression which compresses the read image data, a memory 803 for storing the image data, a memory area 804 for storage of compressed image data which is set in a storage area of the memory 803, a memory area 805 for storage of uncompressed data set for initially storing uncompressed image data sent from the external terminal, a memory control section 806 for controlling the reading and writing of data in the memory 803, a data processing section 807 for decompression which decompresses the compressed image data, a signal processing section 808 for image writing which outputs a signal for forming an image according to the decompressed image data to a laser diode 401 of the printer section 40, a nonvolatile memory 810 as a storage section for storing setting data of setting information of a job, etc., a control section 809 for serial communication with control sections 221, 303, 402 respectively provided in the scanner section 22, the display/operation section 30 and the printer section 40 to control synchronization among the sections, a memory 812 for providing working memory space to the control section 809, a communication interface 811 for exchanging control information, etc., with the external terminal 101, 102 by data communication through LAN 103, and the like.

The scanner section 22 is provided with the above-described image sensor 23 and a control section 221 for controlling image reading. The display/operation section 30 is provided with a display section 301 such as a liquid crystal panel, a touch panel 302 provided on a display surface of the display section 301 as an operation section, an operation panel which is not shown as an operation section and includes a plurality of operation keys, and a control section 303 for controlling a display of the display section 301, for processing signals input from the touch panel 302 and the operation panel and the like. The printer section 40 comprises the above-described laser diode (LD) 401 of the laser unit 42b which performs processing of light exposure and a control section 402 for controlling image forming processing.

Among the above-described structures, the control sections which control the setting registration and read out of the setting of the programming job are the control section 809 of the image processing section 80 and the control section 303 of the display/operation section 30.

Next, the operation of the image forming processing performed by the above-described image forming apparatus 1 will be described. First, the processing of forming an image with a normal job and registration and read out of a normal job will be described.

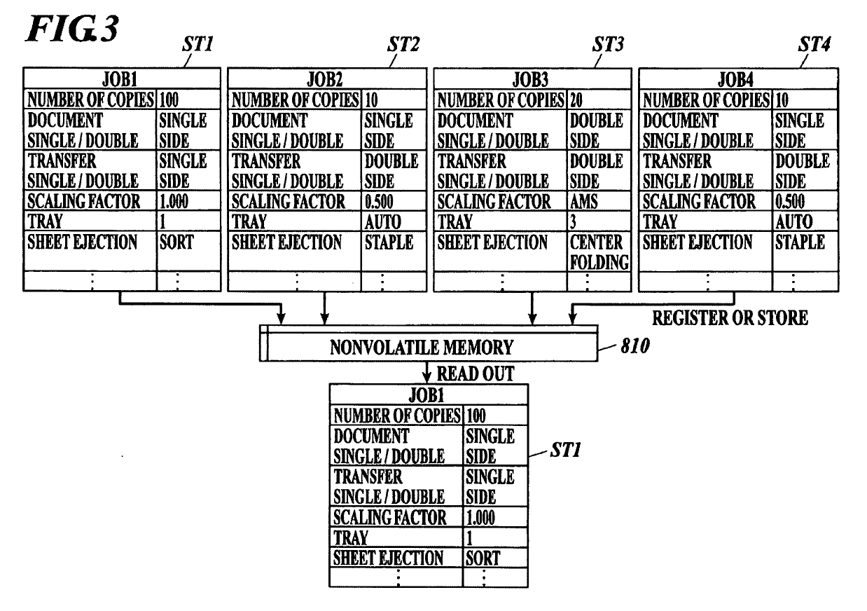

FIG. 3 is an explanatory diagram showing a form of a registration processing and a read out processing of a normal job.

A normal job shows one unit of output processing where a reading condition of a document and an image forming condition is the same in image data constituting a plurality of pages. As shown in pieces of setting information ST1 to ST4 of FIG. 3, setting items of the normal job include, number of copies of image forming, setting of whether the document image is double-sided or single-sided, setting of whether image forming is performed double-sided or single-sided, scaling factor of image forming, setting of sheet feeding tray, method of sheet ejection and finishing, etc.

When image forming of the normal job is performed, the user first inputs setting information of the normal job using an operation screen displayed on the display section 301. The operation screen displays the above-described setting items which can be selected, and the user can input the setting information of the normal job by selecting the content of the setting item using the touch panel 302, etc.

When setting information of the normal job is input, next, the user sets a document on the ADF 21 or the document stage and operates the display/operation section 30 to read the document. With this, the document is read with the document reading section 20 according to the setting information of the above-described normal job. When the document is read, the image forming processing may be started by a predetermined operation on the display/operation section 30. When the image forming processing is started, according to the setting information of the normal job, a predetermined sheet is fed from the sheet feeding mechanism 50 and this sheet is sent to the printer section 40 to form an image of the read document image. Then, the sheet with the image formed is sent to the sheet ejection mechanism 60 and predetermined finishing and sheet ejection is performed according to the setting information of the normal job. Such processing is done successively according to the number of set copies.

In the above-described reading processing of a document image, the document image is obtained as an image signal by the image sensor 23 and the image signal is converted to image data in the signal processing section 801. Then, the data processing section 802 compresses the image data and the memory control section 806 stores the data in the storage area 804 of the memory 803. In the above-described image forming processing, the image data of the image to be formed on the sheet is read out from the storage area 804 of the memory 803 and decompressed in the data processing section 807 for decompression. Next, the decompressed image data is converted to a signal for image writing in the signal processing section 808 and sent to the laser diode 401. The laser diode 401 outputs a laser to the photoreceptor drum 42a according to the image data, and simultaneously, the sheet is passed through between the photoreceptor drum 42a and the transfer unit 42c to form a toner image on the sheet according to the image data. Then, the toner is fused on the sheet in the fusing section 43 and the sheet is ejected.

After the above-described input processing of setting information of the normal job, the registration of the normal job is performed by operation of registration of the job information on the display/operation section 30. When the operation of registration is performed, selection of registration number and input of registration name is requested, and by selection and input, the setting information ST1 of the normal job is sent from the working memory 812 to the nonvolatile memory 810 and stored as setting information of the normal job. The pieces of setting information ST1, ST2, . . . of the normal jobs are data listing the index information (“JOB1” to “JOB4”) showing the registration number and data showing the content of the above-described setting items.

The read out of the setting information of the normal job is performed by operation of call up and read out of the job information on the display/operation section 30. When the operation of call up is performed, a list of the registered job information is output on the display section 301 so that desired job information may be selected from the list and operation of read out may be performed. When the operation of the read out of a normal job is performed, the setting information of the selected normal job is read out from the nonvolatile memory 810 and developed in the working memory 812. The control section 809 recognizes this as the setting data of the reading processing of the document and the image forming processing. The content displayed on the display section 301 displays this setting information. For example, FIG. 3 shows an example where the first setting information ST1 is selected by a user and developed from the nonvolatile memory 810 to the working memory 812. After the setting information is read out, a user sets a document in the document reading section 20 to read the document and thereafter starts the image forming. Thus, the processing of image forming can be performed according to the setting information.

Next, the image forming processing according to a programming job will be described.

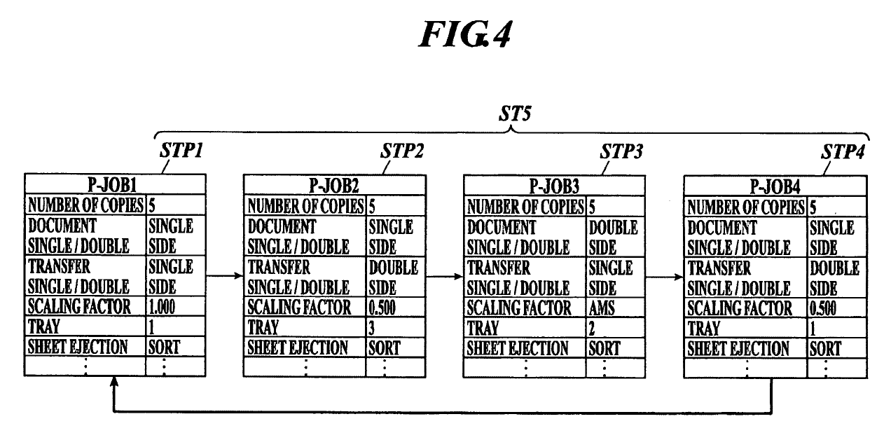

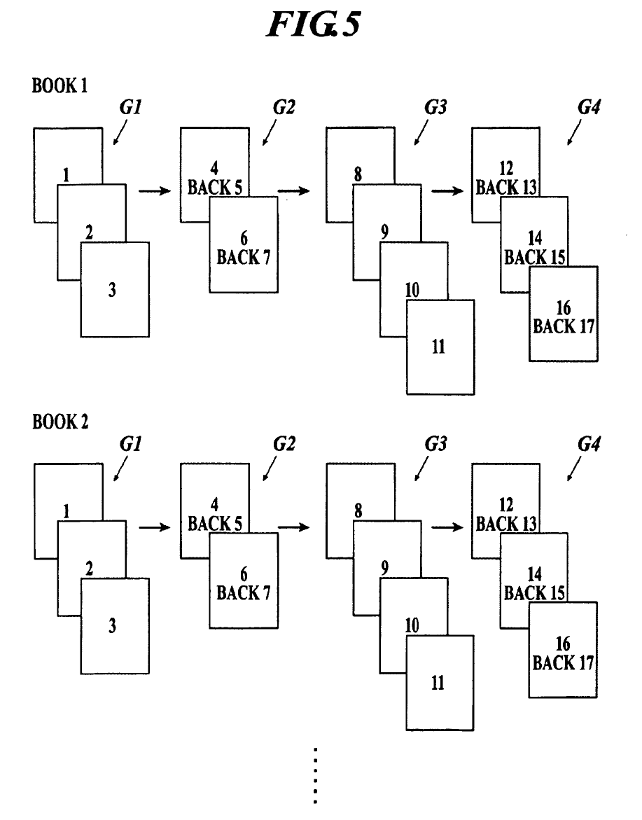

FIG. 4 is an explanatory diagram showing the setting of the programming job and FIG. 5 is an explanatory diagram showing the content of image forming processing of the programming job performed according to this setting.

A programming job shows one unit of output processing where processing of image forming of a plurality of jobs in which a condition of document reading and image forming are not the same are set to be performed successively. In a programming job, a portion where setting of document reading and image forming are common are called a constituting job. The constituting job is a job unit. Thus, as shown in FIG. 4, the setting information ST5 of the programming job is data of the pieces of setting information STP1 to STP4 of the constituting jobs corresponding to a sequence of image forming.

The pieces of setting information STP1 to STP4 of the constituting jobs include the same setting items as the pieces of setting information ST1 to ST4 of the normal jobs shown in FIG. 3. The pieces of index information (“P-JOB1” to “P-JOB4”) in the pieces of setting information STP1 to STP4 of the constituting jobs show a sequence of the constituting jobs in one programming job.

According to the set program job, first, reading processing of a document is performed with respect to constituting jobs according to the pieces of setting information STP1 to STP3 of the constituting jobs. For example, a plurality of pages (for example, three pages) of a single-sided document for forming an image of same magnification according to the setting information STP1 of the first constituting job are read, a plurality of pages (for example, four pages) of a single-sided document with a 50% reduced scale according to the setting information STP2 of the second constituting job are read, a plurality of pages (for example, four pages) of a double-sided document with an auto scaling factor according to the setting information STP3 of the third constituting job are read and a plurality of pages (for example, 6 pages) of a single-sided document with a 50% reduced scale according to the setting information STP4 of the fourth constituting job are read. In the present embodiment, the pieces of setting information STP1, STP2 . . . of the constituting jobs are not provided with an item to specify a number of pages of the document, and the number of pages is judged when the document is read.

When the document reading ends and the operation of performing the programming job is finished, the image forming processing as shown in FIG. 5 is performed. That is, according to the setting information STP1 of the first constituting job and the above-described processing of document reading, first, sheets are fed from the sheet feeding tray “1” and image forming G1 is performed with the document pages (three pages) read in the same magnification and single-sided. Then, according to the setting information STP2 of the second constituting job and the above-described processing of document reading, sheets are fed from the sheet feeding tray “3” and image forming G2 is performed with the pages (four pages) read in 50% reduced scale and double-sided. Similarly, image forming G3, G4 is successively performed according to the pieces of setting information STP3, STP4. Image forming of a book comprising a plurality of pages with different reading conditions of the documents and image forming conditions is performed with this processing. This image forming processing is repeated according to the predetermined number of copies.

In the above-described pieces of setting information STP1 to STP4 of the constituting jobs, setting of a predetermined setting item is limited and set to a common value in order to meet a predetermined condition. For example, the setting of the setting items “number of copies” and “sheet ejection” showing where the sheet is to be ejected are limited to be the common value in the pieces of setting information STP1 to STP4 of the constituting jobs. This is because an object of the image forming processing of the programming job is to form a book by ejecting all pages of the sheets to the same destination. Also, the setting of “tray” setting showing the sheet feeding tray is limited to only the sheet feeding tray which supplies the sheets with the same size. This is because an object of the image forming processing of the programming job is to form a book in which the sheets of all pages are the same size. The item in which the setting is limited is not limited to the above-described items. For example, other items may be limited or if an object of the programming job is not limited to forming a book, even the above-described items do not need to be limited.

Next, a data form of the setting condition when the programming job is registered or read out will be described.

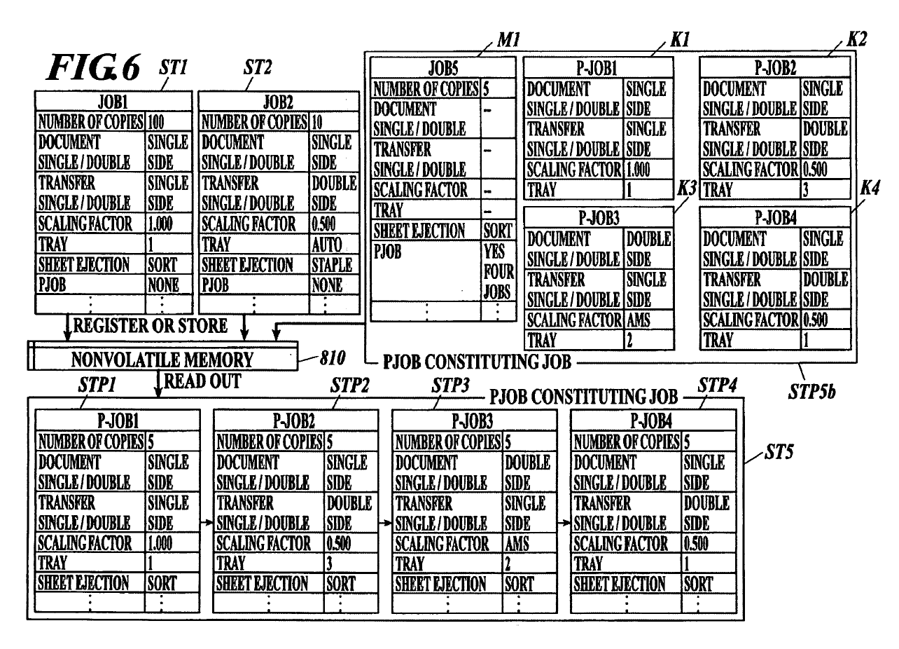

FIG. 6 is an explanatory diagram showing a form of registration processing and read out processing of the programming job.

The data form of the setting information ST5, ST5b of the programming job are different between when stored in the nonvolatile memory 810 in registration processing (ST5b) and when developed in a working memory 812 when the user inputs or the control section 809 performs read out processing (ST5).

That is, when stored in the nonvolatile memory 810, as shown in the setting information ST5b in FIG. 6, the data is in a separated data form between one main job information Ml which is extracted information only of specific items limited to be the common value in all constituting jobs, and pieces of constituting job information K1 to K4 which are extracted information only of items set to different values with respect to each constituting job. The main job information M1 and the plurality of pieces of constituting job information K1 to K4 are stored in a form associated to each other as a piece of setting information ST5b of a programming job. For example, when the information is stored as one data file or the information M1 and K1 to K4 are each stored as separate data files, the pieces of information are stored in one data folder associated with each other according to file name and index information.

In a developed state in the working memory 812, as shown in the setting information ST5 in FIG. 6, the data is in a data form where the pieces of setting information STP1 to STP4 including information of all items with respect to each constituting job is developed according to the number of constituting jobs.

A setting item “PJOB” showing whether the setting information is a programming job or a normal job is added to the pieces of setting information ST1, ST2, ST5b . . . of the normal job and the programming job stored in the nonvolatile memory 810 which is not shown in FIG. 3. In the pieces of setting information ST1, ST2 of the normal job, “PJOB” is set to “none” and in the setting information ST5 of the programming job, this item is added to the main job information M1 and set to “yes”. When “PJOB” is set to “yes”, the number of the constituting job may also be included. The item “PJOB” may be added only when stored in the nonvolatile memory 810 and may be omitted when developed in the working memory 812.

Next, the registration operation and the read out operation of the programming job will be explained.

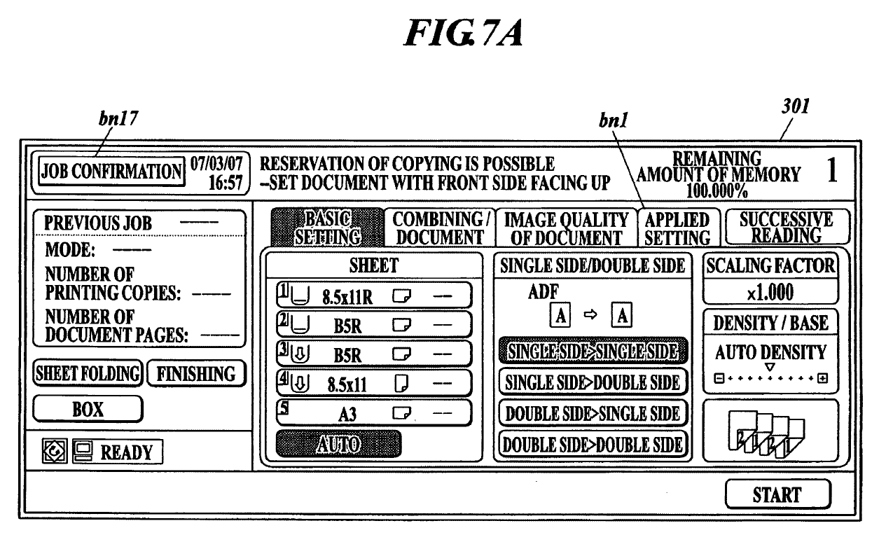

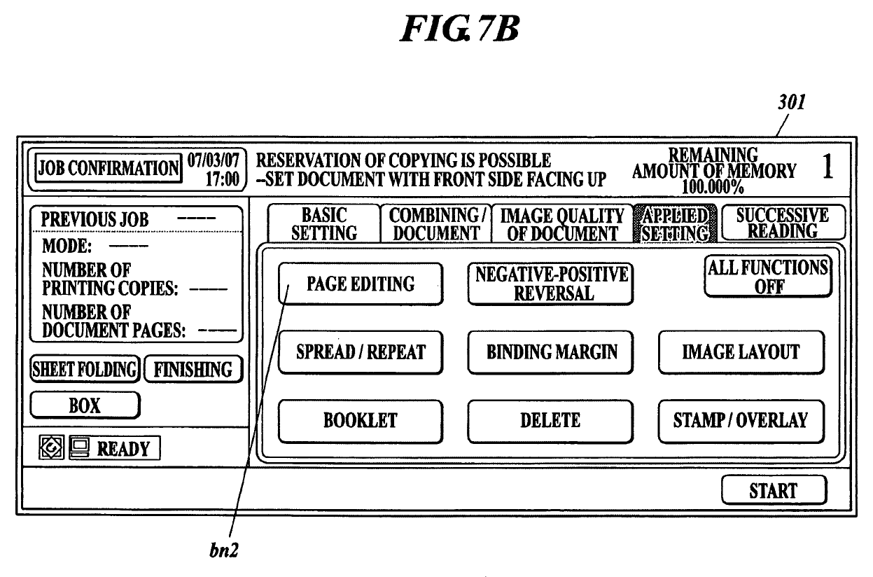

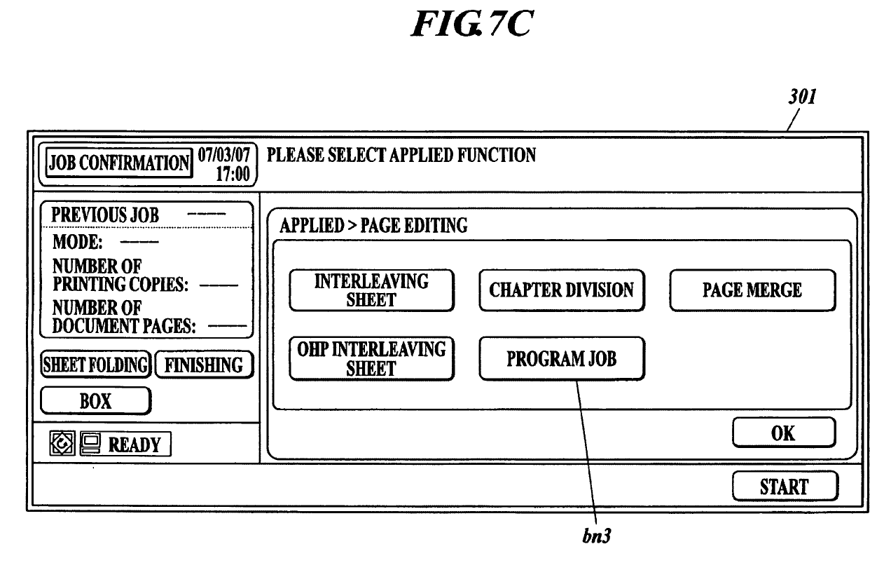

FIG. 7A to FIG. 12C show operation screens of the first process to the eighteenth process when the programming job is registered.

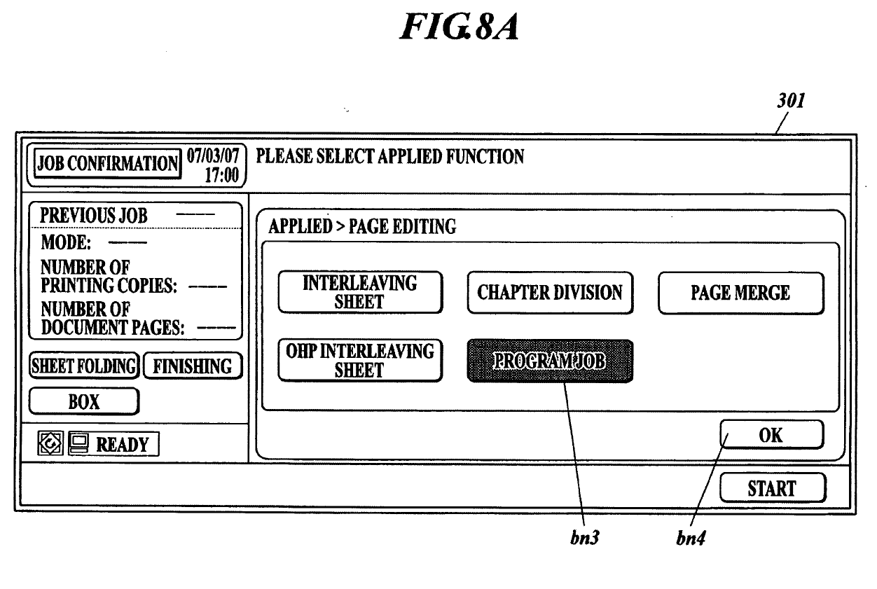

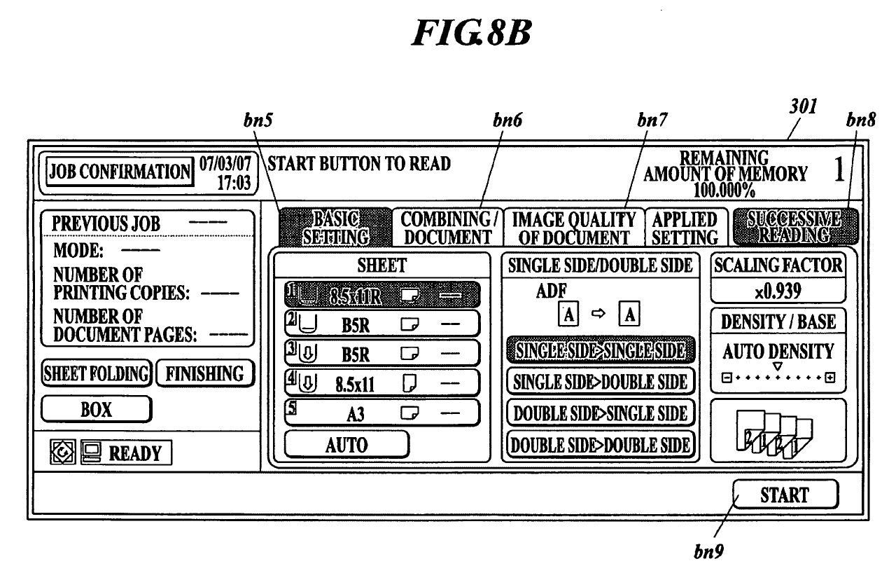

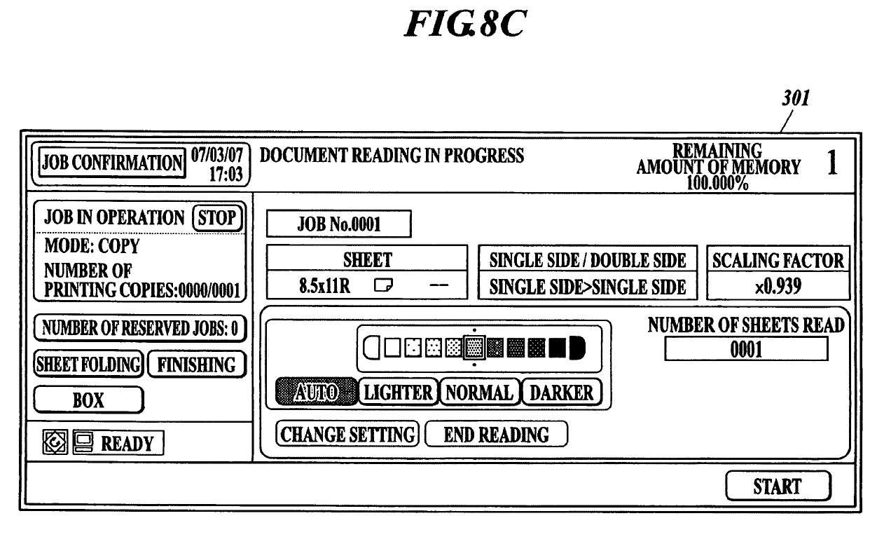

The input processing and the registration processing of the programming job are performed with the following process. First, when the idling basic screen shown in FIG. 7A is displayed on the display section 301 of the display/operation section 30, the user pushes down an operation key bn1 “applied setting” to advance to a selection screen of the applied setting shown in FIG. 7B. When an operation key bn2 “page editing” is pushed down on the selection screen, the screen advances to a selection screen of the page editing shown in FIG. 7C, and when an operation key bn3 “program job” and an operation key bn4 “OK” is pushed down (FIG. 8A), the input processing of the programming job starts.

When the input processing of the programming job starts, as shown in FIG. 8B, the screen advances to an operation screen for setting a reading condition of the document and image forming condition. This operation screen is a screen for setting one constituting job in a programming job and is similar to the operation screen for inputting a condition of a normal job. Unlike the input processing of the normal job, during input processing of the programming job, an operation key bn8 “successive reading” showing a plurality of setting input of constituting jobs and document reading are performed successively is selected so discrimination between setting input of a normal job and setting input of a programming job is possible.

On the operation screen shown in FIG. 8B, the user sets setting of whether the document is read single-sided or double-sided, whether the image is formed single-sided or double-sided, density and scaling factor of the image formed, sheet (sheet feeding tray), finishing, and where the sheet is ejected. By setting the number of copies to be formed by operating the numeric keys (not shown) or by operating the display tab key bn5 to bn7 and changing a portion of the contents of the operation screen, other detailed setting is possible. The input content is to be the setting of one constituting job in the programming job. The setting of the constituting job firstly input in the input processing of the programming job is the setting of the constituting job firstly used for the image forming processing among the constituting jobs of the programming job.

When the setting ends, the user sets a document in the image reading section 20 and pushes down an operation key bn9 “start”. The input content of the operation screen is sent to the control section 809 of the image processing section 80 and is developed in the memory 812. Simultaneously, an instruction to read the document is sent from the control section 809 of the image processing section 80 to the control section 221 of the scanner section 22 and the reading processing of the document image starts in the image reading section 20. When the document includes a plurality of pages, by setting the document in an automatic sheet feeding mechanism 21, the document with the plurality of pages is sequentially read successively. When the document is read, the operation screen advances to the screen for document reading shown in FIG. 8C. The setting of the density of the image may be changed on the operation screen of the reading processing of the document.

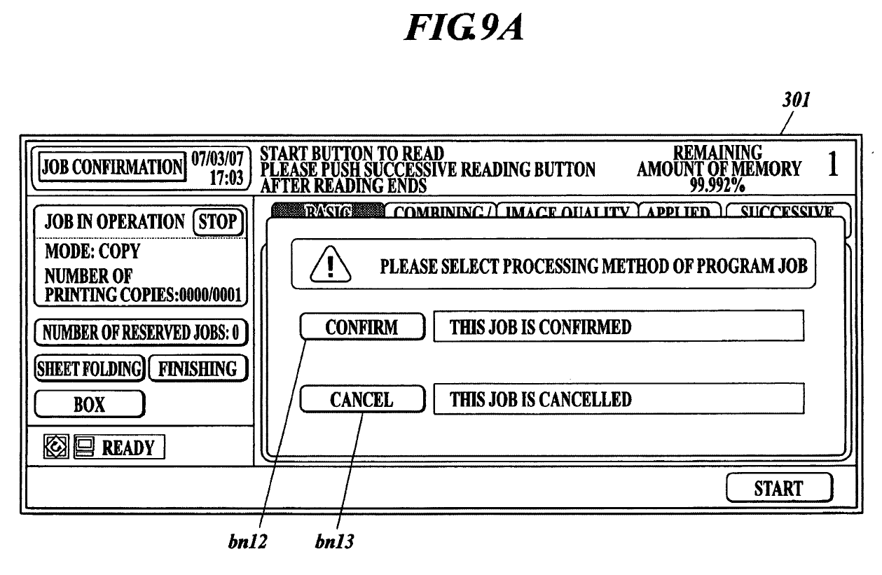

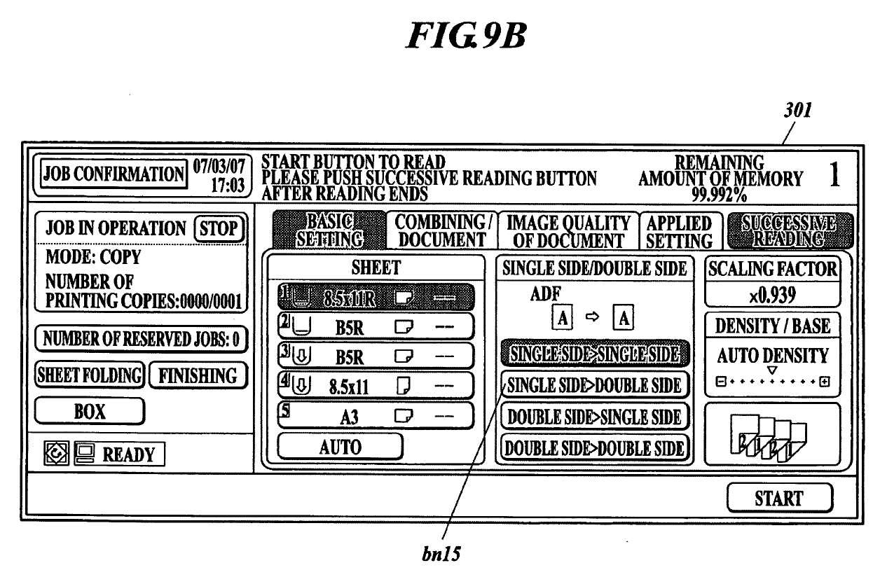

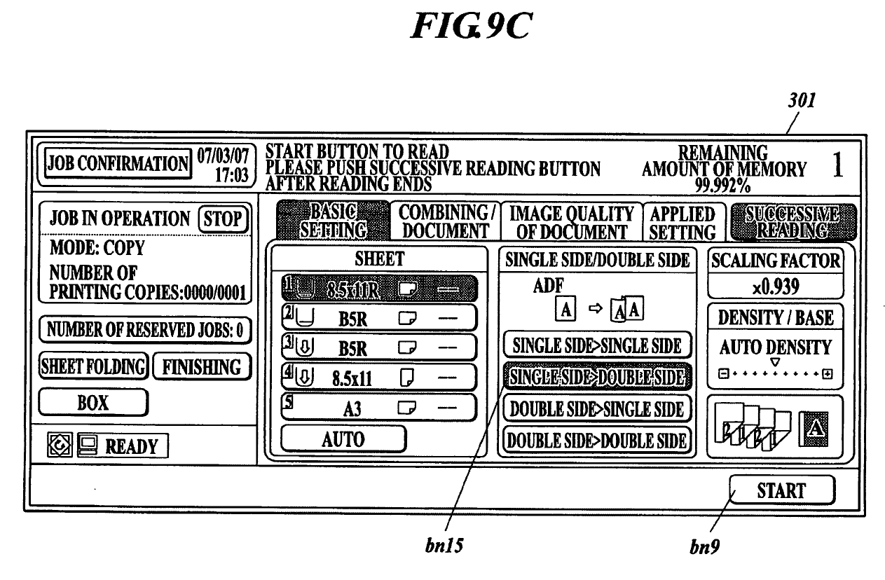

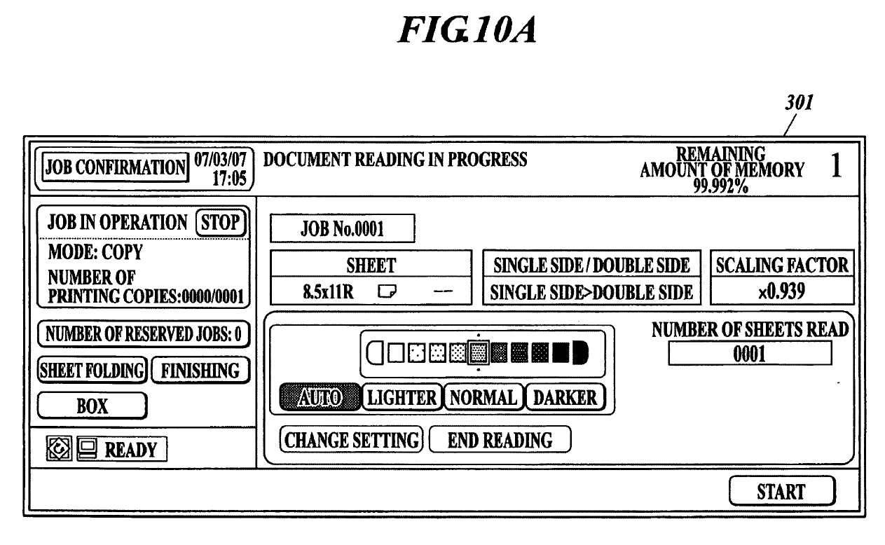

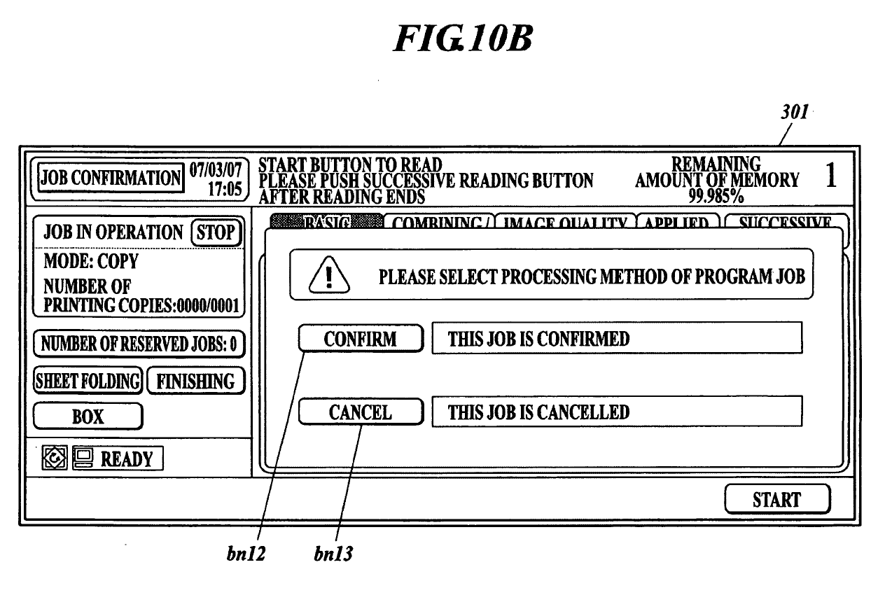

When all of the set documents are read, the information is sent from the control section 221 of the scanner section 22 through the control section 809 of the image processing section 80 to the control section 303 of the display/operation section 30 and as shown in FIG. 9A, the screen advances to an operation screen where the user can select confirmation of input or cancellation of the setting content of the one constituting job of which setting was input and document was read directly before. Here, by pushing down an operation key bn12 “confirm”, the setting content of the one constituting job and the document image data input directly before is confirmed, and the screen advances to an operation screen for inputting a setting of the next constituting job shown in FIG. 9B. When an operation key bn13 “cancel” is pushed down, the setting content of the constituting job and the image data of the document input directly before is cancelled, for example, the setting of the constituting job developed in the memory 812 is deleted and the image data of the document concerning the constituting job stored in the memory 803 is also deleted. Then, the screen returns to the operation screen for inputting a setting of the previous constituting job (for example the operation screen of FIG. 8B).

When the operation key bn12 “confirm” is pushed down and the screen advances to the operation screen shown in FIG. 9B, the inputting of a setting of the next constituting job may be done on this operation screen. An initially selected content of the operation screen displays the setting input of the previous constituting job. The item (for example, number of copies, where to eject sheets, size of the sheet to be fed, etc.) which is limited to be the common setting in all constituting jobs is set as a default and a selection other than the limited setting cannot be made. Thus, as shown in FIG. 9C the user changes the setting of items which may be changed, and performs inputting of a setting of the next constituting job. For example, in the examples of FIG. 9B and FIG. 9C, the first constituting job set with document reading of single-side and image forming on single-side is changed to document reading of single-side and image forming on double-side by pushing down an operation key bn15.

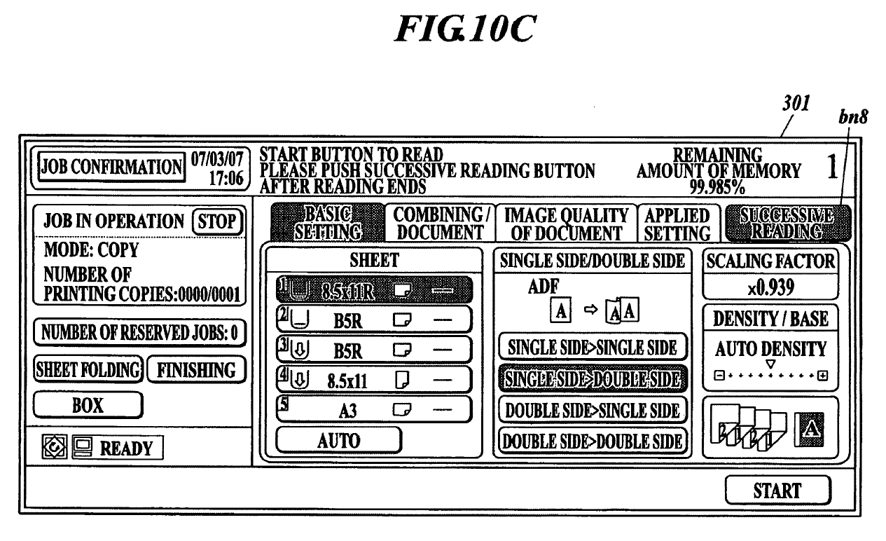

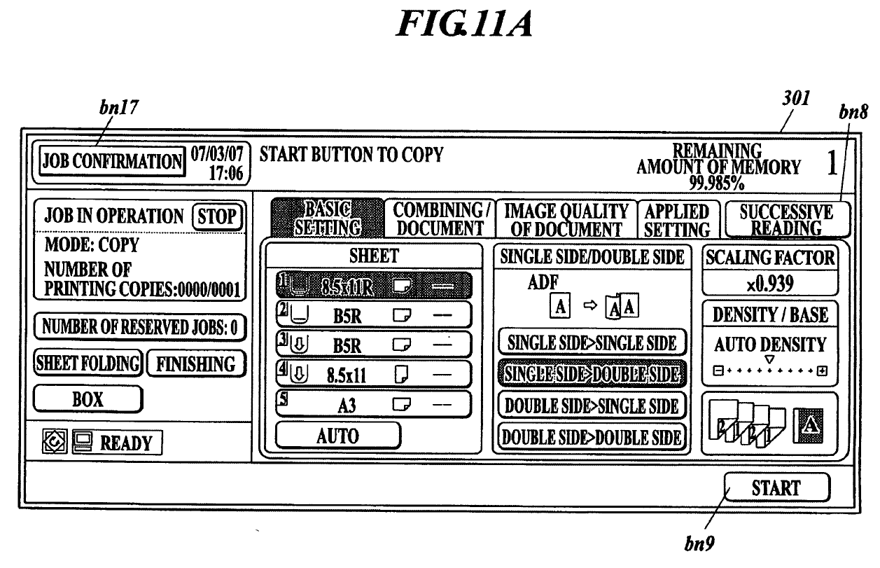

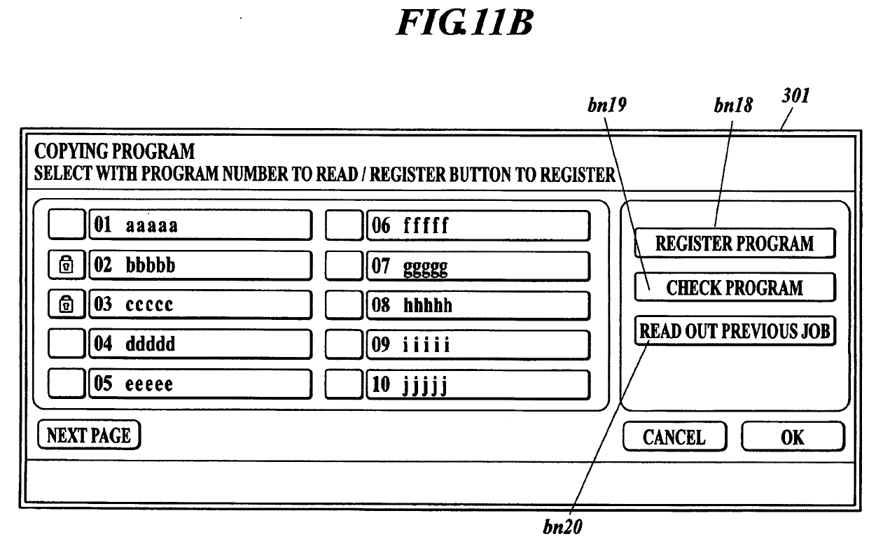

When the inputting of a setting of the constituting job (for example, second constituting job) ends, as with the previous example, the document is set and the operation key bn9 “start” is pushed down. The screen advances to an operation screen shown in FIG. 10A and the document is read. When the reading ends, the screen advances to an operation screen shown in FIG. 10B, and it is possible to confirm or cancel the setting of this constituting job and the image data of the document.

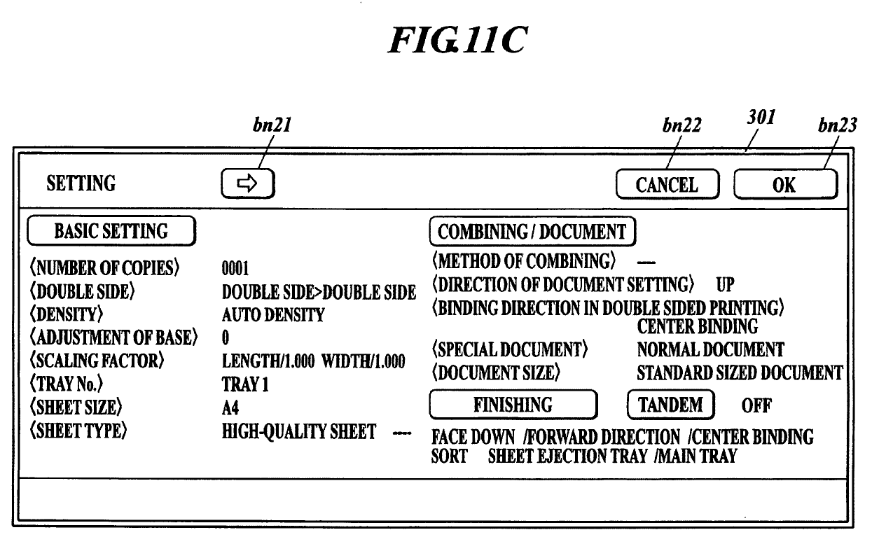

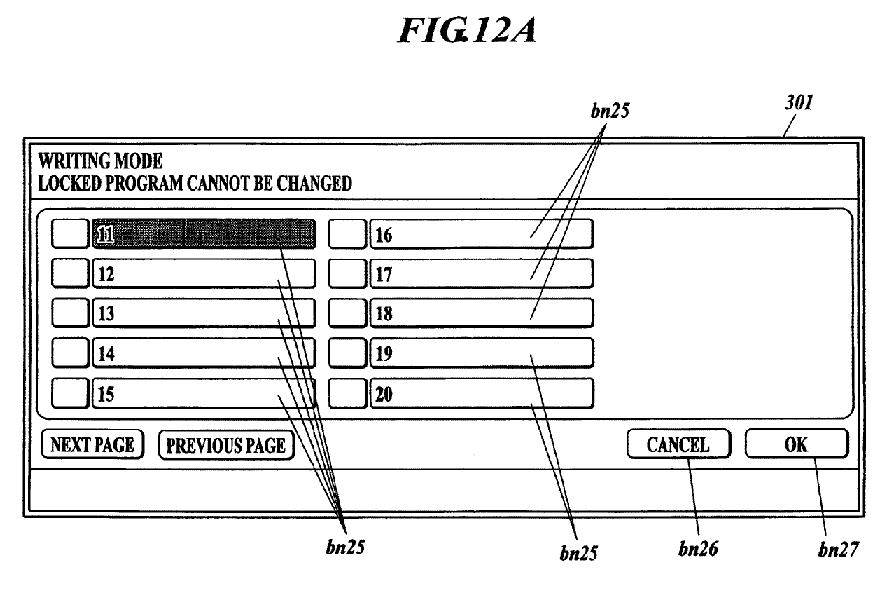

The user may repeat the input of a setting of the above-described FIG. 9B to FIG. 10B a plurality of times and perform inputting of a plurality of setting of constituting jobs and reading of document images. When inputting of a setting of all constituting jobs are finished, as shown in FIG. 10C to FIG. 11A, the operation key bn8 “successive reading” is pushed down, and the state of successive reading (setting input of the programming job) is cancelled. Thus ends the setting input of the programming job.

When the inputting of a setting of the programming job ends, by pushing down an operation key bn9 “start” of the operation screen when setting is finished (FIG. 11A), the image forming processing of the programming job may be started. With this start operation, as shown in FIG. 4 and FIG. 5 the image forming of a plurality of constituting jobs whose setting was input is successively performed and repeated according to the set number of copies, and a plurality of copies of books based on the programming job is formed.

When the inputting of a setting of the programming job ends, the setting information of the programming job may be registered in the memory with the following process. That is, first, operation of calling up a registered job is performed on the operation screen (FIG. 11A) when the setting ends (for example, pushing down an operation key bn17 “job confirmation”). Then, as shown in FIG. 11B, the screen advances to a screen displaying a list of registered jobs. By pushing down the operation key bn18 “register program” on this screen, the process advances to the registration processing of the setting information of the programming job previously input.

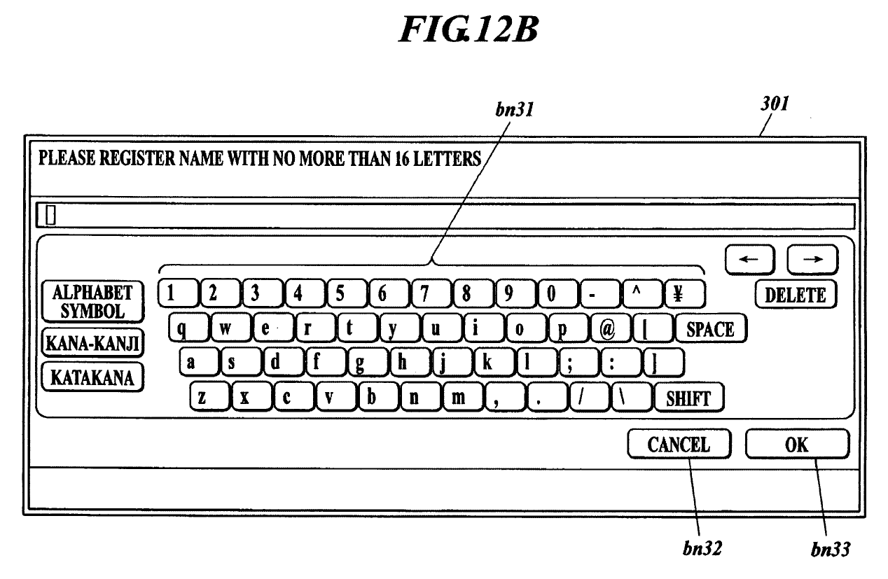

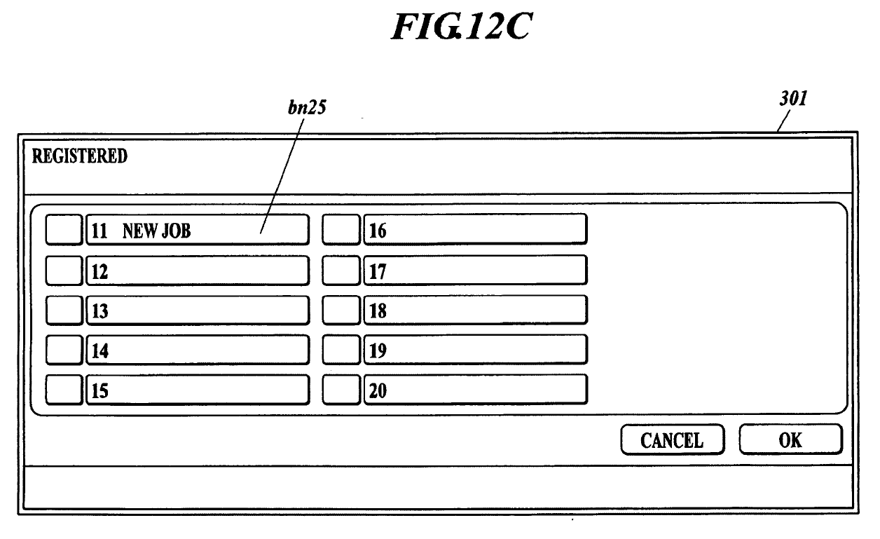

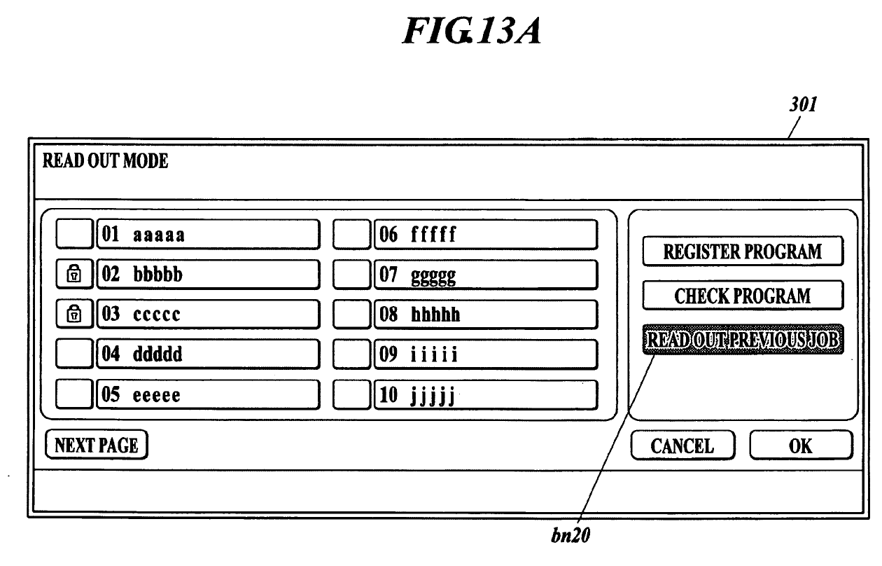

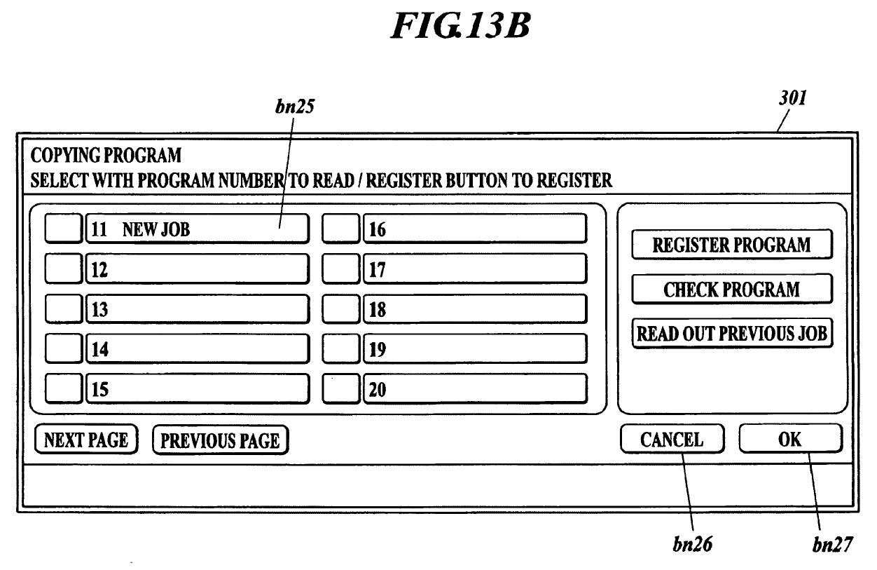

When the registration processing starts, as shown in FIG. 11C, first, the screen advances to a confirmation screen of the setting information of the registered programming job. An operation key bn21 for switching pages (“advance” or “return”) is displayed on the confirmation screen and the display may be switched among a plurality of pieces of setting information of constituting jobs and confirmed. When an operation key bn22 “cancel” is pushed down, the registration of the setting information of the programming job is cancelled, and when an operation key bn23 “OK” is pushed down, selection processing of registration number for registering the setting information (select registration number display area bn25 and push down “OK” key bn27 shown in FIG. 12A) and input processing of registration name (input of character input key bn31 and push down “OK” key bn33 shown in FIG. 12B) is performed to register the setting information of the programming job. When the setting information of the programming job is registered, as shown in FIG. 12C, the registered name (for example, “New Job”) is displayed in the relevant registration number display area bn25 and end of the registration is displayed to the user.

With the operation of the registration of the setting information, as shown in FIG. 6, the setting information STP5 of the programming job developed in the working memory 812 is stored in a predetermined area of the nonvolatile memory 810 as setting information ST5b with the form changed for storage.

Next, the read out processing of the registered setting information of the programming job will be described.

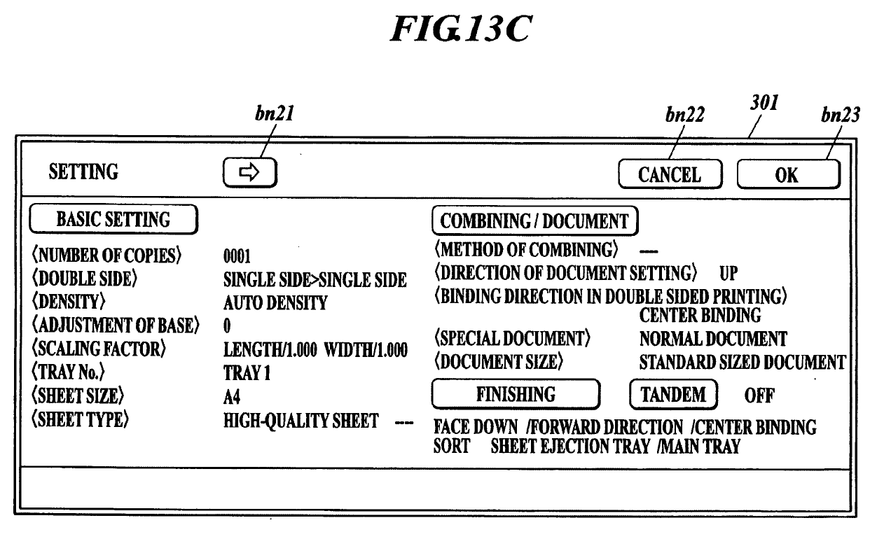

FIG. 13 shows a content of the operation screen when the programming job is read out.

In order to read out the registered setting information of the programming job, first, operation of calling up the registered job (for example, pushing down the operation key bn17 “job confirmation”) is performed on the basic screen shown in FIG. 7A and the screen advances to a display of a list of the registered jobs as shown in FIG. 13A. Operation key bn20 “previous job read out” on this screen is pushed down and advances to setting information read out mode. Then, as shown in FIG. 13B, the registration number display area bn25 of the programming job to be read out is selected and the key bn27 “OK” is pushed down. As shown in FIG. 13C, the setting information confirmation screen is displayed, and when the setting information is checked and there is no mistake, the operation key bn23 “OK” is pushed down. As shown in FIG. 6, the setting information ST5b of the programming job stored in the nonvolatile memory 810 is read out by the control section 809 and developed to the working memory 812. With this, the image forming processing according to the programming job can be performed.

Specifically, when the above-described setting information of the programming job is read out, the setting information of each constituting job is read out one by one, and the setting information is displayed while waiting for reading of the document (for example, a status shown in FIG. 8B). When the operation key bn9 “start” is pushed down, the document is read and the reading ends, next the information of the constituting job is read out and again waits for reading of the document. When this processing is repeated according to the number of constituting jobs, read out of the setting information of one programming job ends, and the image forming processing may be started (for example, as shown in FIG. 11A).

When the read out of the setting information of the programming job and the reading of the document ends, the image forming processing is started and a set number of copies of a book and the like are formed according to the setting information of the programming job.

Next, processing of registration (storage) of setting information of the programming job in the nonvolatile memory 810 and processing of read out from the nonvolatile memory 810 will be described in detail with reference to the flow charts.

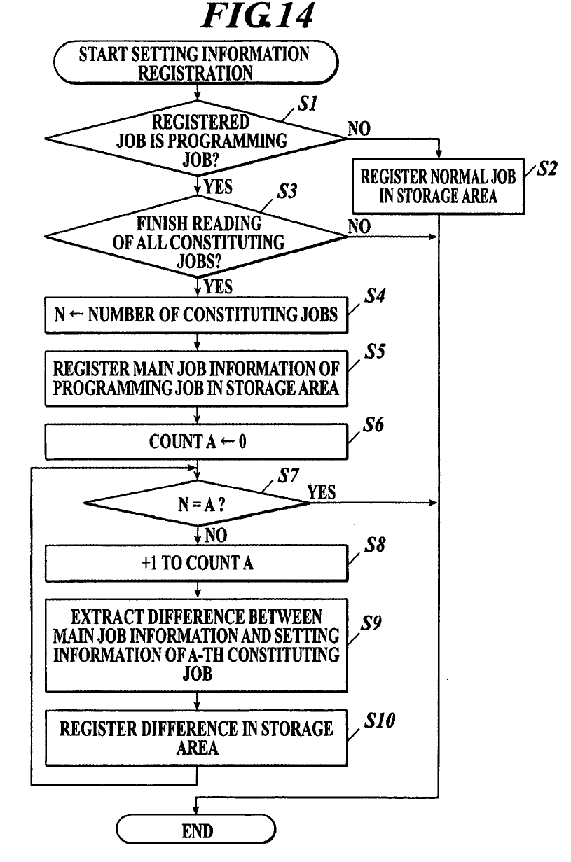

FIG. 14 is a flow chart showing the registration processing of setting information of a normal job or a program job performed by the control section 809 of the image forming section 80.

As shown in the description of FIG. 12A and FIG. 12B, the registration processing of the setting information is processing which starts when the selection of the registration number and the input of the registration name is finished. When the registration processing starts, first, it is determined whether the setting information to be registered is that of the programming job or the normal job (step S1), and when it is the setting information of the normal job, the setting information is registered (stored) in the storage area of the nonvolatile memory 810 and the registration processing ends. When it is the setting information of the programming job, it is judged whether input of setting information of all constituting jobs are finished (for example, whether or not the operation key bn8 “successive reading” is cancelled)(step S3), and when the input of the setting information of all constituting jobs is not finished (step S3, NO), the registration processing ends.

When the setting information is that of the programming job and it is confirmed that input of the setting information of all constituting jobs are finished (step S3, YES), firstly the number of constituting jobs is assigned to a variable N (step S4), next, the main job information M (see FIG. 6) which is the setting of the setting information common in all constituting jobs is registered in the storage area of the nonvolatile memory 810 (step S5). Then, “0” is set to the variable A which shows a sequence number of the constituting jobs (step S6). It is judged whether the values of the variable N and the variable A are the same (step S7) and when they are not the same, “1” is added to the value of the variable A (step S8).

Then, the difference between the setting information of the A-th constituting job and the main job information M1 is extracted (step S9). The differences in the information are to be the pieces of constituting job information K1 to K4 shown in FIG. 6. The A-th constituting job information is registered in the storage area of the nonvolatile memory 810 (step S10). The registration of the constituting job information is associated with the main job information M1 registered in step S5. The processing is returned to step S7 and the processing of steps S7 to S10 is repeated until the variables N and A are the same.

With this processing, the main job information M1 of the programming job and all of the pieces of constituting job information K1, K2 . . . are registered associated with each other in a predetermined area of the nonvolatile memory 810.

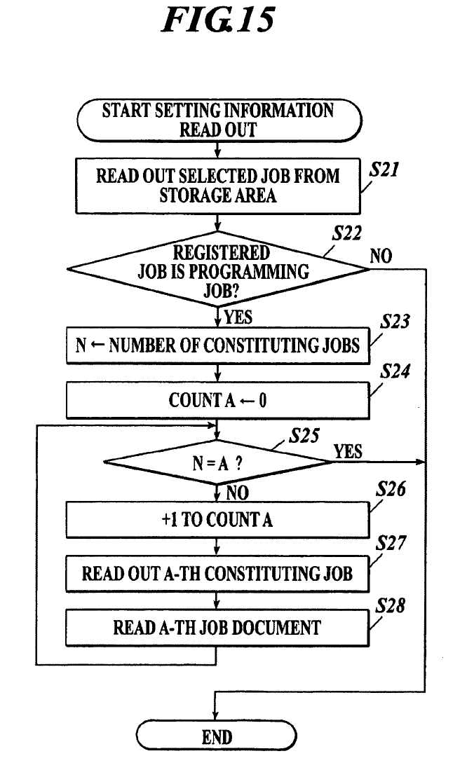

FIG. 15 is a flow chart showing a process of read out processing of setting information of the normal job or the program job.

As shown in the description of FIG. 13, the read out processing of the setting information is a processing started when the registration number is selected in the read out mode of the setting information. When this read out processing is started, first, the setting information corresponding to the selected registration number is read out from the storage area of the nonvolatile memory 810 (step S21). Here, when the setting information corresponding to the registration number is that of the normal job, all of the setting information is read out, whereas when the setting information is that of the programming job, only the main job information M1 (see FIG. 6) is read out.

Then, it is judged whether the read out setting information is that of the programming job or the normal job (step S22), and when it is the setting information of the normal job (step S22, NO), the read out processing ends, whereas when it is the setting information of the programming job (step S22, YES), the number of constituting jobs is input in the variable N (step S23), and “0” is set in the variable A showing the sequence number of the constituting job (step S24). It is judged whether the values of the variable N and the variable A are the same (step S25) and when they are not the same, “1” is added to the value of the variable A (step S26). Then, the A-th constituting job information (any one of K1, K2, . . . : see FIG. 6) is read out and combined with the main job information M1 read out in step S21 to be developed in the working memory 812 as a setting information (any one of STP1, STP2 . . . : see FIG. 6) of one constituting job. Next, the document reading processing is performed reflecting the setting information of the constituting job (step S28). The processing returns to step S25, and the processing of steps S25 to S28 is repeated until the variables N and A are the same.

With this processing, as shown in FIG. 6, the setting information ST5b of the programming job registered in the nonvolatile memory 810 is read out as the pieces of setting information STP1, STP2 . . . with respect to each constituting job, and the reading of the document is performed reflecting the pieces of setting information STP1, STP2, . . . of each constituting job.

As described above, according to the image forming apparatus 1 of the present embodiment, the setting information of the programming job may be registered in the nonvolatile memory 810 and this setting information may be read out and set as a condition of reading a document and image forming. Consequently, when a programming job with the same setting is used many times, the inputting of a setting may be omitted and the processing time may be reduced.

The registration of the setting information of the programming job may be performed just by repeating the processing similar to the inputting of a setting of a normal job according to the number of constituting jobs and then ending the input of the programming job setting (canceling operation key bn8 “successive reading”). Consequently, even when the display section 301 of the display/operation section 30 can only display the operation screen for input of one constituting job setting, the setting registration of the programming job may be easily understood and performed by the user.

When the setting information of the programming job is read out, the setting of the programming job may be performed by repeating the read out of setting information of the normal job and processing of the document reading according to the number of constituting jobs. Consequently, even when performing read out of the setting information of the programming job, the user may easily understand and perform the processing.

When the setting information of the programming job is registered, the main job information M1 which is a value common in all of the constituting jobs is extracted and stored in the nonvolatile memory 810. Consequently, the storage space of the nonvolatile memory 810 necessary for this information may be saved. The storage space which may be saved is not so large when there are only a few constituting jobs, however, when there are, for example, a large number of constituting jobs such as 100 constituting jobs, a relatively large amount of storage can be saved.

The present invention is not limited to the above-described embodiment and various modifications may be made. For example, the number or types of items of setting information of the job, the content or operation method of the operation screen for setting and registering setting information of the job, and other details specifically shown in the embodiment may be modified without leaving the scope of the invention.

According to an aspect of the preferred embodiments of the present invention, there is provided an image forming apparatus comprising:

an image forming section to form images on sheets;

a display section to display an operation screen;

an operation section to receive input of a condition of image forming using the operation screen;

a storage section to store setting information of image forming input from the operation section; and

a control section to control image forming, wherein

when a plurality of pieces of setting information of jobs are successively input, the control section stores the plurality of pieces of setting information of the jobs as one piece of setting information of a programming job in the storage section and the plurality of pieces of setting information of the jobs may be read out as the setting information of the programming job.

According to this aspect, the setting information of the programming job may be registered in the storage section and the information may be read out for setting the apparatus. Consequently, when the same setting information is used many times, the input of the setting information of the programming job may be omitted, and operation may be more efficient.

Preferably, the display section displays the operation screen which can receive input of the setting information with respect to jobs; and

in a processing of input of the setting information of the programming job the control section repeats the processing of, displaying the operation screen with respect to jobs on the display section to receive input of the setting information of one of the jobs and when document reading with the setting information of the one of the jobs ends, displaying the operation screen on the display section to receive the setting information of another of the jobs, and

when the input of the programming job ends in the repeated processing, the plurality of pieces of setting information input in the repeated processing are stored in the storage section as the programming job.

Since the setting registration of the programming job may be performed by repeating the inputting of a setting in the unit of the normal job a plurality of times, consequently, the user may easily understand and perform the processing.

Preferably, when the plurality of pieces of setting information of the jobs are successively input as the setting information of the programming job, the control section limits input of a predetermined item of the setting information so that values of the item are a common value among the plurality of pieces of setting information and the common value of the item is stored as common data in the storage section and values of an item of the setting information which are not limited are stored with respect to the setting information in the storage section.

Since a plurality of input of common data do not have to be stored in order to store the setting information of the programming job, consequently, the storage space of the storage section may be saved.

Preferably, the image forming apparatus further comprises an image reading section to read an image of a document, wherein

the setting information of the programming job includes a condition of reading the document, and

the control section reads out the setting information of the programming job from the storage section by repeating a processing of, displaying the setting information input with respect to jobs in an order of input on the operation screen as well as reading an image of a document with the image reading section according to the displayed setting information, and when the document reading ends, displaying setting information of a next job on the operation screen.

Since the read out of the setting information of the programming job and the setting of the apparatus may be performed by repeating the read out processing of the setting in the unit of jobs, consequently, the user may easily understand and perform the processing.

The present U.S. patent application claims priority under the Paris Convention of Japanese Patent Application No. 2007-126729 filed on May 11, 2007 to the Japanese Patent Office, which shall be a basis for correcting mistranslations.

What is claimed is:

1. An image forming apparatus comprising:
an image forming section to form images on sheets;
a display section to display an operation screen;
an operation section to receive input of a condition of image forming using the operation screen;
a storage section to store setting information of image forming input from the operation section; and
a control section to control image forming, wherein
when a plurality of pieces of setting information of jobs are successively input, the control section stores the plurality of pieces of setting information of the jobs as one piece of setting information of a programming job in the storage section and the plurality of pieces of setting information of the jobs may be read out as the setting information of the programming job.

2. The image forming apparatus of claim 1, wherein the display section displays the operation screen which can receive input of the setting information with respect to jobs; and
in a processing of input of the setting information of the programming job the control section repeats the processing of, displaying the operation screen with respect to jobs on the display section to receive input of the setting information of one of the jobs and when document reading with the setting information of the one of the jobs ends, displaying the operation screen on the display section to receive the setting information of another of the jobs, and
when the input of the programming job ends in the repeated processing, the plurality of pieces of setting information input in the repeated processing are stored in the storage section as the programming job.

3. The image forming apparatus of claim 1, wherein when the plurality of pieces of setting information of the jobs are successively input as the setting information of the programming job, the control section limits input of a predetermined item of the setting information so that values of the item are a common value among the plurality of pieces of setting information and the common value of the item is stored as common data in the storage section and values of an item of the setting information which are not limited are stored with respect to the setting information in the storage section.

4. The image forming apparatus of claim 1, further comprising an image reading section to read an image of a document, wherein
the setting information of the programming job includes a condition of reading the document, and
the control section reads out the setting information of the programming job from the storage section by repeating a processing of, displaying the setting information input with respect to jobs in an order of input on the operation screen as well as reading an image of a document with the image reading section according to the displayed setting information, and when the document reading ends, displaying setting information of a next job on the operation screen.
